(19) United States
(12) Patent Application Publication
(10) Pub. No.: US 2008/0217127 A1
(43) Pub. Date: Sep. 11, 2008

(54) Shock absorber

(75) Inventor: Chikatoshi Abe, Tokyo (JP)

Correspondence Address: RABIN & Berdo, PC, 1101 14TH STREET, NW, SUITE 500, WASHINGTON, DC, 20005, US

(73) Assignee: KAYABA INDUSTRY CO., LTD., Tokyo (JP)

(21) Appl. No.: 12/073,329

(22) Filed: Mar. 4, 2008

(30) Foreign Application Priority Data
Mar. 9, 2007 (JP) 2007-060211

(51) Int. Cl. F16F 9/10

(52) U.S. Cl. 188/312

(57) ABSTRACT

In a shock absorber (D), a rod (3) projects axially from a cylinder (1) housed in an outer tube (2) to the exterior of the outer tube (2). A rod guide (4, 11) supports the outer circumference of the rod (3) so as to be free to slide. The rod guide (4, 11) also closes openings of the cylinder (1) and the outer tube (2). The rod guide (4, 11) comprises a cylindrical part (4a, 11a) which is inserted into the cylinder (1). By inserting a cylindrical spacer (5, 12) between the cylindrical part (4a, 11a) of the rod guide (4) and the inner circumference of the cylinder (1) so as to compensate for a gap therebetween, plural shock absorbers (D) comprising cylinders (1) of different inner diameters can be manufactured using rod guides (4, 11) of an identical size.

### FIELD OF THE INVENTION

This invention relates to a rod guide which supports a rod projecting from a cylinder of a shock absorber.

### BACKGROUND OF THE INVENTION

JP2003-343633A, published by the Japan Patent Office in 2003, and JP2005-256969A, published by the Japan Patent Office in 2005, disclose a double-tube type hydraulic shock absorber which has an outer tube for housing a cylinder.

The shock absorber comprises a rod guide fitted to an opening of the cylinder and an opening of the outer tube so as to support a piston rod projecting axially from within the cylinder to the exterior of the outer tube so as to be free to slide.

The rod guide comprises a cylindrical part, and a fitting part formed on the outer circumference of an upper end of the cylindrical part and having a larger diameter than the cylindrical part. The cylindrical part is fitted into the opening of the cylinder whereas the fitting part is fitted into the opening of the outer tube. By bending a tip of the outer tube around the opening inward, the rod guide is gripped between the cylinder and the outer tube.

### SUMMARY OF THE INVENTION

The rod guide has a function to support the piston rod so as to be free to slide. It also has a function to separate the interior of the cylinder from a reservoir constituted by an annular gap formed between the cylinder and the outer tube. Still further, it has a function to position the piston rod, the cylinder, and the outer tube so as to be concentric.

In order to make the rod guide fully functional, it is preferable that the cylindrical part of the rod guide fits into the inner circumference of the tip of the cylinder without clearance. When shock absorbers having cylinders of different inner diameters are manufactured, therefore, rod guides having cylindrical parts of different outer diameters have to be used.

When the rod guides are manufactured by sintering or metal press work, plural metal molds are required to manufacture the rod guides having different dimensions. Use of plural metal molds, however, increases the manufacturing cost of shock absorbers. Further, when manufacturing rod guides having cylindrical parts of different inner diameters, it is necessary to handle rod guides which are similar in shape but different in size, which makes parts control complicated.

Still further, when manufacturing the rod guides having cylindrical parts of different outer diameters, there may be a deviation in the required manufacturing amounts of the rod guides depending on the outer diameters of the cylindrical parts. With respect to a rod guide that has a very small manufacturing amount, volume efficiency in production cannot be obtained.

It is therefore an object of this invention to manufacture shock absorbers having cylinders of different inner diameters using a common rod guide.

In order to achieve the above object, this invention provides a shock absorber comprising an outer tube, a cylinder housed in the outer tube coaxially therewith, a rod projecting axially from the cylinder to the exterior of the outer tube, and a rod guide which supports the outer circumference of the rod so as to be free to slide and closes an opening of the cylinder and an opening of the outer tube. The rod guide has a cylindrical part inserted into the cylinder. The shock absorber further comprises a cylindrical spacer which is interposed between the cylindrical part of the rod guide and the cylinder.

The details as well as other features and advantages of this invention are set forth in the remainder of the specification and are shown in the accompanying drawings.

### BRIEF DESCRIPTION OF THE DRAWINGS

FIG. 1 is a longitudinal sectional view of a head portion of a hydraulic shock absorber according to this invention.

FIG. 2 is a longitudinal sectional view of a head portion of a hydraulic shock absorber according to a further embodiment of this invention.

### DESCRIPTION OF THE PREFERRED EMBODIMENTS

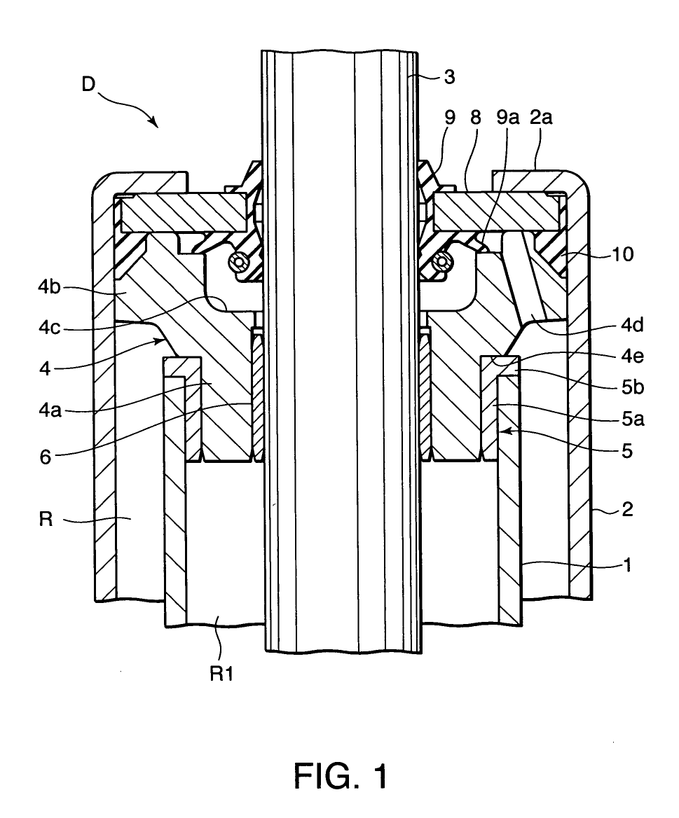

Referring to FIG. 1 of the drawings, a hydraulic shock absorber D comprises a cylinder 1, an outer tube 2 housing the cylinder 1, and a rod 3 projecting axially from the cylinder 1 to the exterior of the outer tube 2 so as to be free to slide. The cylinder 1 is fixed in the interior of the outer tube 2 coaxially therewith. The rod 3 is supported so as to be free to slide axially by a rod guide 4 which is fixed to openings of the cylinder 1 and the outer tube 2. The rod guide 4 also has a function to close the openings of the cylinder 1 and the outer tube 2.

The cylinder 1 is filled with working oil. A piston not shown is fixed to a lower end of the rod 3. The interior of the cylinder 1 is divided into two oil chambers by the piston, specifically, a rod side oil chamber R1 formed above the piston and a piston side oil chamber formed below the piston. A reservoir R which is filled with gas and working oil is formed in a space between the cylinder 1 and the outer tube 2.

The rod guide 4 comprises a small diameter cylindrical part 4a inserted into the opening of the cylinder 1 and a large diameter fitting part 4b extending radially from an upper end of the cylindrical part 4a via a step 4e and fitted to the inner circumference of the outer tube 2. The outer diameter of the cylindrical part 4a is set in advance to be smaller than the inner diameter of the cylinder 1. The cylindrical part 4a of the rod guide 4 is fitted to the inner circumferential surface of the cylinder 1 via a cylindrical spacer 5.

By being fitted into an annular gap which is formed by the outer circumferential surface of the cylindrical part 4a of the rod guide 4 and the inner circumferential surface of the cylinder 1, the spacer 5 compensates for the difference in the outer diameter of the cylindrical part 4a and the inner diameter of the cylinder 1.

The spacer 5 comprises a cylindrical main body 5a which is fitted into the annular gap and a flange 5b extending radially from an upper end of the main body 5a. The flange 5b is gripped between an upper end of the cylinder 1 and the step 4e of the rod guide 4, thereby keeping the spacer 5 at the upper end of the cylinder 1.

The rod guide 4 is not fitted directly to the inner circumferential surface of the cylinder 1, but to the inner circumferential surface of the spacer 5. In contrast, the large diameter fitting part 4b of the rod guide 4 is fitted directly to the inner circumferential surface of the opening of the outer tube 2.

The openings of the cylinder 1 and the outer tube 2 are thus closed by the rod guide 4, respectively.

A cylindrical slide bearing 6 is fitted to the inner circumference of the cylindrical part 4a of the rod guide 4. The slide bearing 6 supports the rod 3 so as to be free to slide axially. A recess 4c facing the rod 3 is formed in the fitting part 4b of the rod guide 4. A communicating hole 4d is formed through the fitting part 4b so as to connect the recess 4c to the reservoir R. The communicating hole 4d functions to return working oil that leaks out to the recess 4c through sliding surfaces between the rod 3 and the slide bearing 6, to the reservoir R.

The rod guide 4 is fixed in a predetermined position shown in the figure by bending an upper end of the outer tube 2 inward. When the upper end of the outer tube 2 is bent inward, an annular insert metal 8 is inserted between the rod guide 4 and a bent portion 2a at the upper end of the outer tube 2.

An inner circumferential seal 9 made of an elastic material is fitted onto an inner circumference of the insert metal 8. The inner circumferential seal 9 has two contact parts which are in contact with the rod 3 above and below the insert metal 8. Of the two contact parts of the inner circumferential seal 9, the contact part located above the insert metal 8 functions as a dust seal and the contact part located below the insert metal 8 functions as an oil seal. The recess 4c is shut off from the outside by the inner circumferential seal 9. The inner circumferential seal 9 further comprises a lip 9a which functions as a check valve that allows working oil to flow from the recess 4c into the communicating hole 4d while preventing working oil from flowing in the opposite direction.

An outer circumferential seal member 10 made of elastic material is fitted onto an outer circumference of the insert metal 8 so as to ensure oil-tightness in the fitting surfaces of the rod guide 4 and the outer tube 2.

An axial force acting on the rod guide 4 when bending the upper end of the outer tube 2 inward so as to fix the rod guide 4 between the upper ends of the outer tube 2 and the cylinder 1, is supported by the cylinder 1 via the step 4e of the rod guide 4 and the flange 5b of the spacer 5.

As described above, the hydraulic shock absorber D is provided with the spacer 5 between the rod guide 4 and the cylinder 1. By applying spacers 5 having different outer diameters, therefore, the same rod guide 4 can be used in cylinders 1 having different inner diameters.

By thus enabling the rod guides 4 of the same size to be used in cylinders 1 of various inner diameters, the manufacturing cost of the hydraulic shock absorber D can be decreased.

Since rod guides of different inner diameters are not required to construct shock absorbers provided with the cylinders 1 having different inner diameters as described above, the hydraulic shock absorbers can be manufactured at low cost according to this invention.

It is preferable to set the outer diameter of the cylindrical part 4a of the rod guide 4 to be equal to the smallest inner diameter of the cylinders 1. In this case, the rod guide 4 is fitted into the cylinder 1 having the smallest inner diameter without using the spacer 5. With respect to the other cylinders 1 having greater inner diameters, the rod guide 4 is fitted to the cylinder 1 using one of the spacers 5. According to this arrangement, the number of sizes of the spacers 5 can be decreased.

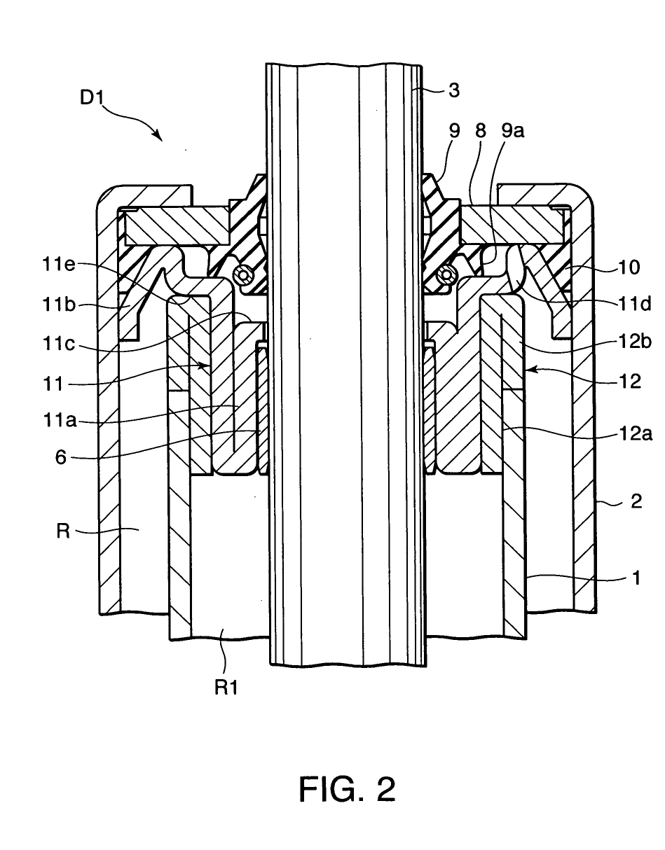

Referring to FIG. 2, a further embodiment of this invention will be described.

A hydraulic shock absorber D1 according to this embodiment uses a rod guide 11 manufactured by press work instead of the rod guide 4 of the first embodiment.

In this shock absorber D1, a cylindrical part 11a of the rod guide 11 has a twofold structure and is fitted to the cylinder 1 via a spacer 12 which has a similar twofold structure. According to this embodiment, since the cylindrical part 11a supporting the rod 3 via a slide bearing 6 is supported by the spacer 12 from the outside, an effect of reinforcing the cylindrical part 11a with the spacer 12 may be expected.

The rod guide 11 manufactured by press work comprises the cylindrical part 11a having a twofold structure, a step 11e which is formed continuously with an upper end of the cylindrical part 11a so as to be in contact with an upper end of the spacer 12, and a fitting part 11b formed continuously with the outer circumference of the step 11e. A recess 11c facing the rod 3 is formed by the fitting part 11b and a communicating hole 11d connecting the recess 11c to the reservoir R is formed through the fitting part 11b. Since the rod guide 11 is manufactured by press work, the manufacturing cost of the rod guide 11 is lower than the rod guide 4 of the first embodiment.

The spacer 12 is also manufactured by press work. The spacer 12 comprises a cylindrical main body 12a which is fitted between the inner circumference of the cylinder 1 and the outer circumference of the cylindrical part 11a of the rod guide 11, and a fold portion 12b. The fold portion 12b is formed by folding back an upper end of the main body 12 outward. The lower end of the fold portion 12b comes into contact with the upper end of the cylinder 1, thereby keeping the spacer 12 at the upper end of the cylinder 1. The fold portion 12b has increased strength owing to its twofold piping structure. Further, the fold portion 12b located outside the cylindrical part 11c of the rod guide 11 brings about a favorable effect in view of reinforcing the rod guide 11.

When the rod guide 11 is fixed to the shock absorber D1, the upper end of the outer tube 2 is bent inward in a state where the step 11c is in contact with the spacer 12 and the insert metal 8 having the seals 9, 10 is placed on the rod guide 12. An axial force that acts on the rod guide 11 in accompaniment with this bending process is supported by the cylinder 1 via the fold portion 12b of the spacer 12.

The other components of the hydraulic shock absorber D1 are identical to those of the hydraulic shock absorber D according to the first embodiment.

As described above, by applying spacers 12 of different inner diameters, rod guides 11 having an identical size can be fitted to the cylinders 1 having different inner diameters. As a result, hydraulic shock absorbers D1 having the cylinders 1 of different inner diameters can be constituted using rod guides of a single size, thereby decreasing the manufacturing cost of the hydraulic shock absorber D1. Further, manufacturing the rod guide 11 by press work further decreases the manufacturing cost of the shock absorber D1.

The contents of Tokugan 2007-060211, with a filing date of Mar. 9, 2007 in Japan, are hereby incorporated by reference.

Although the invention has been described above with reference to certain embodiments of the invention, the invention is not limited to the embodiments described above. Modifications and variations of the embodiments described above will occur to those skilled in the art, within the scope of the claims.

The embodiments of this invention in which an exclusive property or privilege is claimed are defined as follows:

What is claimed is:

1. A shock absorber comprising:
an outer tube;
a cylinder housed in the outer tube coaxially therewith;
a rod projecting axially from the cylinder to the exterior of the outer tube;
a rod guide which supports the outer circumference of the rod so as to be free to slide and closes an opening of the cylinder and an opening of the outer tube, the rod guide having a cylindrical part inserted into the cylinder; and
a cylindrical spacer which is interposed between the cylindrical part and the cylinder.

2. The shock absorber as defined in claim 1, wherein the spacer comprises a cylindrical main body fitted into the inner circumference of the cylinder and a gripped part which is gripped between the rod guide and the cylinder.

3. The shock absorber as defined in claim 1, wherein the rod guide is gripped between a tip of the outer tube which is bent inward and a tip of the cylinder.

4. The shock absorber as defined in claim 3, further comprising an annular insert metal which is interposed between the tip of the outer tube and the rod guide.

5. The shock absorber as defined in claim 4, wherein the rod guide further comprises a fitting part which is fitted into the inner circumference of the outer tube.

6. The shock absorber as defined in claim 5, further comprising an inner circumferential seal member which is fitted onto the inner circumference of the insert metal and comes in contact with the outer circumference of the rod, and an outer circumferential seal member fitted onto the outer circumference of the insert metal for sealing fitting surfaces between the cylinder and the fitting part.

7. The shock absorber as defined in claim 6, wherein the cylinder is filled with working oil, the shock absorber further comprises a reservoir of working oil in a space between the outer tube and the cylinder, the rod guide has a recess facing the rod and sealed by the inner circumferential seal member and a communicating hole which connects the recess to the reservoir.

8. The shock absorber as defined in claim 7, wherein the inner circumferential seal member further comprises a lip which allows working oil to flow from the recess to the reservoir through the communicating hole while preventing working oil from flowing through the communicating hole in the opposite direction.
